(19) United States
(12) Patent Application Publication
(10) Pub. No.: US 2020/0166015 A1
(43) Pub. Date: May 28, 2020

(54) A METHOD OF COATING A ROTOR BLADE FOR A WIND TURBINE

(71) Applicant: Vestas Wind Systems A/S, Aarhus N (DK)

(72) Inventor: Rasmus Konge Johansen, Grindsted (DK)

(21) Appl. No.: 16/629,106

(22) PCT Filed: Jul. 5, 2018
(86) PCT No.: PCT/DK2018/050180

§ 371 Date: Jan. 7, 2020

(30) Foreign Application Priority Data
Jul. 7, 2017 (DK) PA 2017 70555

(51) Int. Cl. F03D 1/06

(52) U.S. Cl. CPC F03D 1/0675; F03D 1/0633; F05B 2240/301; F05B 2230/10; F05B 2230/311; F05B 2260/96; F05B 2280/6011; F05B 2230/90; F05B 2280/6003

(57) ABSTRACT

A method of coating an area of a wind turbine rotor blade comprises: defining an area to be coated on a surface of the blade, applying a first plurality of strips of masking tape to the surface of the blade proximate a first edge region of the defined area such that each strip is arranged adjacent to at least one other strip of said first plurality of strips, spraying a coating layer onto the defined area up to an innermost strip such that the innermost strip defines an edge of the coating layer, removing the innermost strip(s) to expose an uncoated region of the defined area between the edge of the coating layer and an innermost remaining strip and spraying a further coating layer over the previous coating layer and over the uncoated region up to said innermost remaining strip.

### TECHNICAL FIELD

The present invention relates to coatings for wind turbine rotor blades, and to a method of applying such coatings.

### BACKGROUND

The rotor blades of wind turbines may be exposed to intense environmental conditions in use. Rain, hail, sand, dirt and salty sea water can all gather on the surfaces and lead to soiling and roughening of paint and coating systems. The leading edge of the rotor blade is most susceptible to erosion because it is the first part of the rotor blade to move through the air and therefore experiences the greatest impact with abrasive particulates. Erosion of the leading edge can result in the deterioration of the aerodynamic characteristics of the rotor blade and ultimately may lead to a reduction in the annual energy production (AEP) of the wind turbine.

Leading edge protection (LEP) coatings have been developed to increase the rotor blade's ability to resist erosion at the leading edge. However, such coatings themselves have the potential to adversely impact the aerodynamic efficiency of the rotor blade, in particular when thick coatings are applied because it can be difficult to achieve a smooth transition between coated and uncoated regions of the rotor blade. Without a smooth transition, unwanted flow effects may ensue over the rotor blade surface leading to a reduction in AEP.

Against this background, the present invention aims to provide a method of coating a wind turbine rotor blade that is able to achieve a smooth transition between the coated and uncoated areas of the rotor blade, even when relatively thick coatings are applied.

### SUMMARY OF THE INVENTION

According to an aspect of the present invention there is provided a method of coating an area of a wind turbine rotor blade. The method comprises: defining an area to be coated on a surface of the blade, applying a first plurality of strips of masking tape to the surface of the blade proximate a first edge of the defined area such that each strip is arranged adjacent to at least one other strip of said first plurality of strips, spraying a coating layer onto the defined area up to an innermost strip such that the innermost strip defines an edge of the coating layer, removing the innermost strip(s) to expose an uncoated region of the defined area between the edge of the coating layer and an innermost remaining strip and spraying a further coating layer over the previous coating layer and over the uncoated region up to said innermost remaining strip.

The method may further comprise repeating the steps of removing the innermost strip(s) and spraying a further coating layer as set out above until a coating having a desired thickness is achieved.

The spraying of a further coating layer over the previous layer and uncoated region results in a coating having a thickness that tapers in the first edge region of the defined area. More particularly, the staggering of coating layer results in a final coating having a thickness at its edge that is less than or equal to the thickness of the final coating layer.

The method may further comprise applying a second plurality of strips of masking tape to the surface of the blade proximate a second edge of the defined area such that each strip of the second plurality is arranged adjacent to at least one other strip of the second plurality of strips. The step of spraying a coating layer may comprise spraying the coating layer onto the defined area between the innermost strips of the first and second plurality of strips. The step of removing the innermost strip(s) may comprise removing the innermost strip(s) of the first and second plurality of strips prior to spraying a further coating layer.

The method may comprise applying the first plurality of strips to one of a pressure surface or a suction surface of the blade, and applying the second plurality of strips to the other of the pressure surface or the suction surface.

The defined area may be a leading edge region of the wind turbine blade comprising a leading edge of the blade.

The coating may have a thickness that tapers in a direction towards the trailing edge of the blade.

The coating may, for example, be a leading edge protection paint for resisting environmental erosion of the wind turbine rotor blade.

The method may further comprise allowing the coating layer to dry prior to spraying the further coating layer.

The innermost strip(s) may be removed while the coating layer is still wet so that the coating flows towards the innermost remaining strip. This may cause the coating layer to taper towards an edge thereof.

Applying the strips may comprise temporarily adhering the strips to the surface of the rotor blade. For example, each of the strips may be individually adhered to the surface of the rotor blade.

The method may comprise spraying an outermost coating layer, such that the outermost coating layer is thinner than at least one inner coating layer beneath the outermost coating layer. In embodiments, the outermost layer is thinner than a plurality of inner coating layers or all inner coating layers. For example the outermost coating layer may have a thickness of 50% or less than the thickness of the inner layer(s). The thickness of each layer being a characteristic thickness, defined in a central portion thereof, spaced away from the edge region(s).

According to a further aspect of the present invention there is provided, an assembly comprising a wind turbine rotor blade and an apparatus for applying a coating on a defined area of a surface of said wind turbine rotor blade according to the method of the embodiments described above. The apparatus comprises a plurality of strips of masking tape arranged on the surface of the rotor blade and aligned with each other proximate a leading edge of the rotor blade and means for spraying a coating composition onto the leading edge of the rotor blade up to an innermost of the plurality of strips.

In the method or assembly of any of the embodiments above, the plurality of strips of masking tape may include at least four strips. Two of the four strips may be arranged on a pressure side of the leading edge and a further two of the strips may be arranged on a suction side of the leading edge. In further embodiments, the plurality of strips includes at least six strips with three of the six strips being arranged on a pressure side of the leading edge and three of the strips being arranged on a suction side of the leading edge. For example, the plurality of strips may include twelve strips, with six strips being arranged on a pressure side of the leading edge and six of the strips being arranged on a suction side of the leading edge.

In an embodiment of any of the above, each strip of the plurality of strips of masking tape may be shaped such that, when the strips are attached to the surface of the blade, a portion of each strip overhangs the defined area to be coated, wherein an overhanging portion of a strip serves to create a tapered edge in a coating layer sprayed up to said strip. For example, each strip may have a curved cross-section such as a circular, part-circular, radiused, ovoid or elliptical cross-section. In other examples, the strips may not have a rounded edge but may instead have an angled edge to achieve a similar result, for example a straight edge angled relative to the local surface of the blade.

In a further embodiment of any of the above, each of the plurality of strips of masking tape is made from a foam or rubber material.

According to a further aspect of the present invention, there is provided a wind turbine blade comprising a leading edge protection coating covering a leading edge region of a surface of the blade. The leading edge protection coating comprises an outer coating layer and at least one inner coating layer between the outer coating layer and the outer surface of the blade. The outer coating layer extends beyond at least one edge of the at least one inner coating layer in a direction towards a trailing edge of the blade such that the leading edge protection coating tapers in thickness in a direction towards the trailing edge.

The at least one inner coating layer may include an innermost coating layer and at least one intermediate coating layer between the innermost coating layer and the outer coating layer, the at least one intermediate coating layer extending beyond the at least one edge of the innermost coating layer in a direction towards the trailing edge of the blade.

Each of the coating layers of the leading edge protections coating may taper in thickness in a direction towards the trailing edge of the blade.

### BRIEF DESCRIPTION OF THE DRAWINGS

FIG. 1 shows an example of a wind turbine in accordance with an embodiment of the invention;

FIG. 2a is a plan view of one of the rotor blades of the wind turbine of FIG. 1;

FIG. 2b is a cross-sectional view of the rotor blade of FIG. 2a taken through the line B-B in FIG. 2a;

FIG. 3 is a schematic view of part of a rotor blade surface during application of a coating;

FIG. 4a is a perspective view of a rotor blade during application of a coating in accordance with an embodiment of the invention;

FIG. 4b is a cross-sectional view of the rotor blade of FIG. 4a taken through the line C-C in FIG. 4a;

FIGS. 5 to 10 illustrate various stages of a method of coating a rotor blade in accordance with a further embodiment of the invention; and

FIG. 11 shows a rotor blade including a coating applied in accordance with a further embodiment of the invention.

### DETAILED DESCRIPTION

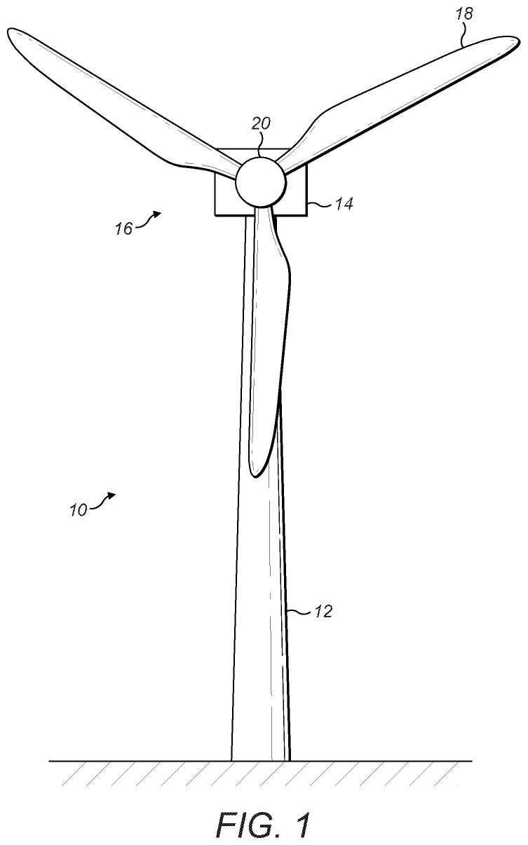

FIG. 1 shows an example of a wind turbine 10 in accordance with an embodiment of the present invention. As shown, the wind turbine 10 comprises a tower 12 supporting a nacelle 14 at its upper end. A rotor 16 is mounted to the nacelle 14. The rotor 16 comprises three rotor blades 18, which are attached to and extend from a central hub 20.

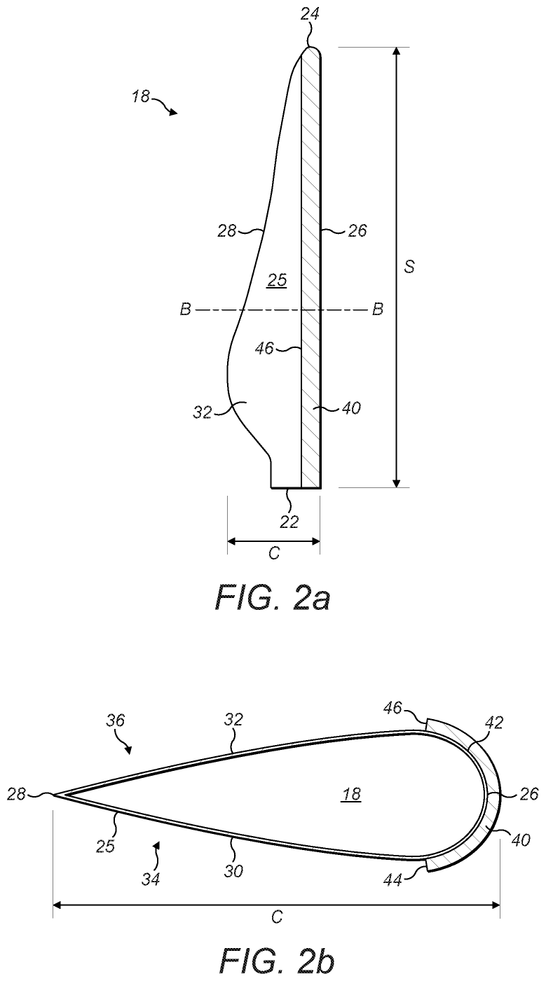

FIG. 2a is a plan view of a rotor blade 18 of the wind turbine of FIG. 1. The rotor blade 18 extends in a spanwise direction S between a root 22, for attachment to the hub, and a tip 24. The rotor blade 18 also extends in a chordwise direction C, generally perpendicular to the spanwise direction S, between a leading edge 26 and a trailing edge 28.

Referring additionally to the sectional view of FIG. 2b, which is taken through the line B-B in FIG. 2a, the rotor blade 18 has an outer surface 25 comprising a pressure surface 30 and a suction surface 32. The pressure surface 30 extends between the leading and trailing edges 26, 28 of the rotor blade 18 on a pressure side 34 (windward side) of the rotor blade 18, and the suction surface 32 extends between the leading and trailing edges 26, 28 on an opposite suction side 36 (leeward side) of the rotor blade 18.

As shown in FIGS. 2a and 2b, the rotor blade 18 further includes a coating 40 on a portion of the outer surface 25 of the rotor blade 18. In this example, the coating 40 is provided on a leading edge region 42 of the rotor blade 18, which is a region particularly susceptible to erosion. Specifically, the coating 40 covers the leading edge 26 of the rotor blade 18 and covers a portion of the pressure surface 30 adjacent the leading edge 26 and a portion of the suction surface 34 adjacent the leading edge 26. In view of the airfoil profile of the rotor blade 18, the coating 40 is therefore curved in cross-section, as shown in FIG. 2b.

In this example, the coating 40 extends over the entire span S of the rotor blade 18 from the root 22 to the tip 24. However, in other embodiments the coating 40 may only be applied to a portion of the span S of the rotor blade 18, or to a plurality of discrete portions.

The coating 40 includes two longitudinal edges 44, 46 extending over the outer surface 25 of the rotor blade 18. A first longitudinal edge 44 extends along the pressure surface 30 of the rotor blade 18 and a second longitudinal edge 46 extends along the suction surface 34 of the rotor blade 18. These edges 44, 46 of the coating 40 define a transition between coated and uncoated areas of the rotor blade 18.

For the avoidance of doubt, the term ‘uncoated’ is used herein to refer to an area of the rotor blade 18 that is not covered by the coating 40 shown, for example, in FIGS. 2a and 2b; it does not exclude this area being covered by other coatings, and the ‘uncoated’ areas in FIGS. 2a and 2b would typically be painted or gel coated.

It has been found that having a smooth transition between coated and uncoated areas of the rotor blade 18 at the edges 44, 46 of the coating 40 provides improved airflow over the rotor blade 18 in comparison to having an abrupt step change in height at this interface, since such abrupt step changes can cause unwanted flow effects that may lead to a reduction in AEP.

The coating 40 may include a plurality of coating layers (see for example layers 52, 54 and 56 shown in FIG. 10) each having a layer thickness which cumulatively defines a total coating thickness. In the illustrated examples, the coating layers preferably comprise paint, however it will be appreciated that other coating types may be applied using the techniques described herein.

The paint may be applied by spraying. For example, the spraying may be performed manually, for example using a hand-held spray device, or it may be automated, for example using a robot-mounted spray device. Use of a hand-held spray device may allow the paint layers to be applied to a wind turbine blade 18 in the field e.g. to upgrade an already operational wind turbine 10. An automated spray device may advantageously be used during initial manufacture of the rotor blade 18 to produce a faster and more repeatable coating method.

The coating 40 is advantageously applied to a particular area on the outer surface 25 of the rotor blade 18. As discussed above, in this example the coating 40 is applied specifically to the leading edge region of the blade, which is an area particularly prone to damage. In other embodiments the coating 40 may alternatively or additionally be applied to other regions of the blade. By restricting the coating 40 to specific areas where damage is most prevalent, costs can be minimised and the additional weight of the blade attributable to the coating 40 is also minimised.

In order to ensure that the coating is only applied to the desired area 42 of the rotor blade 18, masking materials may be used to conceal the surrounding areas during spraying. Various masking materials may be used without departing from the scope of the invention. One particular masking material is a strip of masking tape 64, which may be temporarily adhered to the surface of the rotor blade 18 and used to define the edges of the area to be coated.

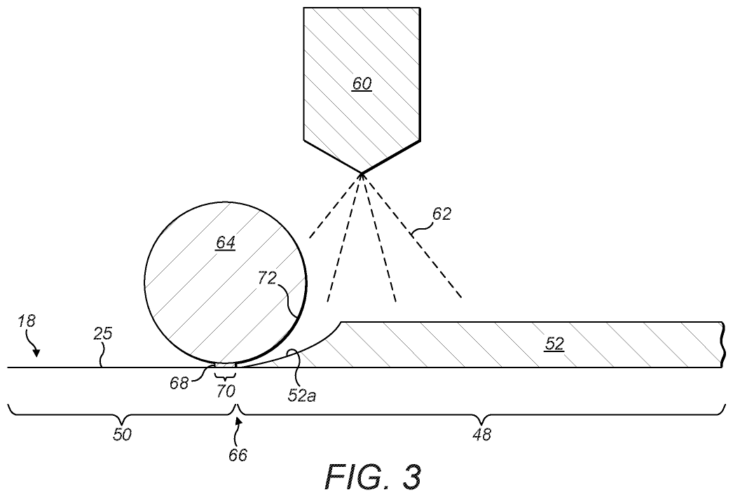

FIG. 3 shows a detail view of paint 62 being applied to the surface of a rotor blade 18 in a particular area by means of a hand-held or automated applicator, e.g. a spraying device 60. The surface includes a first area 48 upon which the paint 62 is required, and a second area 50 upon which the paint 62 is not required. A masking material 64, in the form of an elongate strip of foam masking tape having a generally circular cross-section, is applied to the surface 25 of the rotor blade 18 at a junction 66 between the first area 48 and the second area 50.

The strip of masking tape 64 may include an adhesive strip 68 extending along the length thereof to facilitate attachment of the masking tape 64 to the surface 25 of the rotor blade 18.

The adhesive strip 68 defines a contact area 70 of the masking tape 64. The thickness of the adhesive strip 68 is exaggerated for clarity in FIG. 3; in reality the thickness of the adhesive strip 68 may be negligible.

The adhesive strip 68 removably attaches the masking tape to the outer surface 25 of the rotor blade 18 such that it may be easily removed after spraying of a layer of the paint 62. It will be appreciated that other attachment means may be used to removably attach the masking tape 64 to the surface of the rotor blade 18. For example, the masking tape 64 may be glued to the outer surface 25 using glue applied to the masking tape 64 and/or the outer surface 25 of the rotor blade 18 or other bonding means.

The circular cross-sectional shape of the masking tape 64 is advantageous since it results in a portion 72 of the tape 64 overhanging the first area 48. As will be described in further detail below, this overhanging portion 72 of the tape 64 allows a tapered edge 52a to be achieved in a paint layer 52. The invention is not limited to the use of masking tape having a circular cross-section. Other shapes of tape may be used, however it is particularly advantageous if the shape presents an overhang. Masking tape having a curved profile is therefore particularly suitable (e.g. oval-section or part-circular section tapes or those having radiused or rounded corners). Alternatively, masking tape having a suitably-angled straight edge may be used.

As shown in FIG. 3, during spraying of the paint 62, the overhanging portion 72 of the masking tape 64 partially shields the first area 48 of the outer surface 25 immediately adjacent the masking tape 64. Specifically, the vertical clearance between the overhang 72 of the masking tape 64 and the surface 25 of the first area 48 progressively decreases moving towards the contact area 70 of the masking tape 64. Accordingly, a tapering region is defined between the overhang 72 and the surface 25, which results in the applied paint layer 52 having a tapered edge 52a adjacent the masking tape 64. The degree of taper at the edge region 52a may be controlled by the geometry of the masking tape 64, e.g. the diameter of the circular cross-section or the radius of curvature of a non-circular tape.

Strips of masking tape 64 may be positioned at all edges, i.e. along the entire periphery of the area to be coated. For example, when coating the leading edge region 42 of a rotor blade 18, strips of masking tape may be positioned on both the pressure and suction surfaces 30, 32 (see FIG. 2b) of the blade 18, either side of the leading edge 26, to define a coating area therebetween.

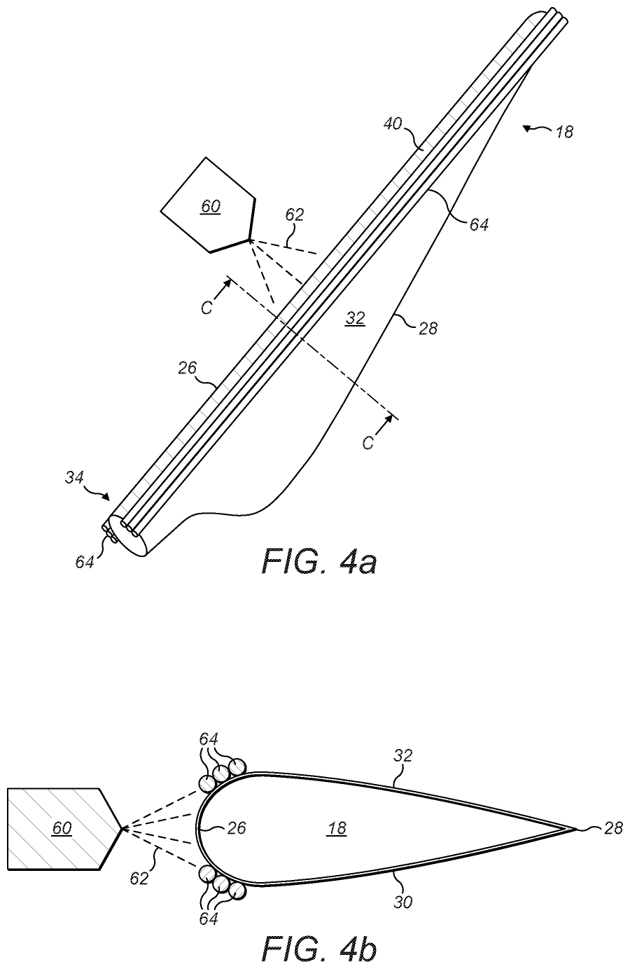

FIGS. 4a and 4b show an arrangement for applying three coating layers to the leading edge 26 of a rotor blade 18. In this arrangement, six strips of masking tape 64 are applied to the outer surface 25 of the rotor blade 18 such that three strips of masking tape 64 are positioned either side of the leading edge 26. From FIG. 4a it can be seen that the strips of masking tape 64 extend along substantially the entire span S of the rotor blade 18 and are parallel aligned with the leading edge 26 such that three strips of masking tape 64 are positioned on the pressure surface 30 and a further three strips of masking tape are positioned on the suction surface 32 of the rotor blade 18. In other examples, the strips may extend only along a part of the span of the blade, and a different number of strips 64 may be used.

FIG. 4b, in particular shows the strips of masking tape arranged substantially symmetrically about the leading edge of the rotor blade 18. The innermost strips of masking tape 64 (i.e. the strips closest to the leading edge 26 on each side) may define between them an area of a first coating layer. The central strips of masking tape of each side may define between them an area of a second coating layer. The outer strips of masking tape (i.e. the strips furthest from the leading edge 26 on each side) may define between them an area of a third and final coating layer.

The use of more than one strip of masking tape 64 along each side of the leading edge 26 allows further tapering of the coating 40 when multiple layers of paint are required. More specifically, the innermost strips of masking tape 64, relative to the leading edge 26, may be removed after each layer of paint is sprayed such that the following paint layer is sprayed up to the second innermost tapes on each side. This causes a staggering of the edges of each subsequent paint layer and further tapering of the overall coating 40.

Such a method will now be explained in more detail below with reference to FIGS. 5 to 10.

FIGS. 5 to 10 each show a cross-section of a rotor blade 18 in a region adjacent a leading edge 26 thereof, during various stages of coating the rotor blade 18 with LEP paint in accordance with a further embodiment of the disclosure.

FIG. 5 shows a detail view of the leading edge region of the blade 18 prior to applying LEP paint. It can be seen that twelve strips of masking tape 64a-l are applied to the outer surface of the rotor blade 18, such that six strips of masking tape 64a-l are attached on either side of the leading edge 26. Specifically, six ‘suction-side strips’ 64a-f are arranged side-by-side on the suction surface 32 of the rotor blade 18, and six ‘pressure-side strips’ 64g-l of masking tape are arranged on the pressure surface 30 of the rotor blade 18 and are aligned with each other along the span S of the rotor blade 18.

The strips 64a-l preferably extend in a substantially straight line between the root 22 and the tip 24 of the rotor blade 18. The strips may extend along the whole or part of the span of the blade 18, depending upon the extent of the leading edge region that is required to be coated. The strips 64a-l preferably extend substantially parallel to the leading edge 26 of the rotor blade 18.

A first suction-side strip 64a is positioned closest to the leading edge 26, and forms the innermost suction-side strip of masking tape with respect to the area to be coated 38. A second suction-side strip 64b abuts the first suction-side strip 64a on the trailing-edge side thereof, and a third suction-side strip 64c abuts the second suction-side strip 64b on the trailing-edge side thereof, and so on. As such, the suction-side strips 64a-f of masking tape are all parallel aligned with each other.

A first pressure-side strip 64g is positioned closest to the leading edge 26. A second pressure-side strip 64h abuts the first pressure-side strip 64g on the trailing-edge side thereof, and a third pressure-side strip 64i abuts the second pressure-side strip 64h on the trailing-edge side thereof, and so on.

FIG. 5 also indicates (by means of shading) the curved area 38 of the outer surface 25 of the rotor blade 18 over which the final leading-edge coating 40 will extend i.e. the area 38 to be coated. As such, it will be seen that the strips 64a-l are all located proximate an edge of the area 38 to be coated. More particularly, the first to fourth strips of masking tape 64a-d, 64g-j, from each side of the leading edge 26 are positioned within the area 38. The fifth strips of masking tape 64e, 64k are positioned partially within this area 38 over an edge of the area 38, and the sixth strips of masking tape 64f, 641 from each side are positioned outside this area 38.

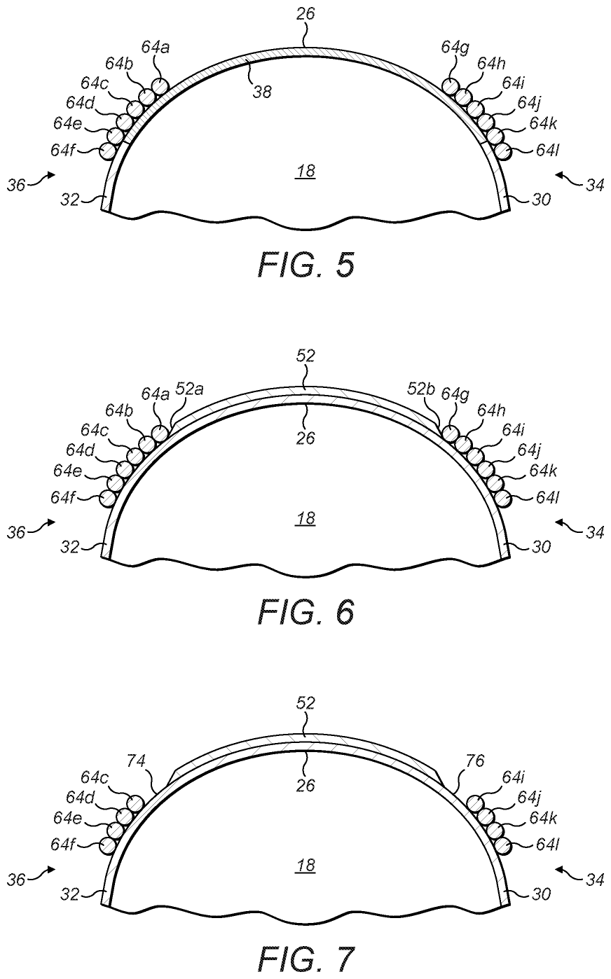

After positioning the suction-side and pressure-side strips of masking tape 64a-l on the rotor blade 18 as shown, a first layer of paint 52 is applied to the outer surface 25 of the rotor blade 18, as shown in FIG. 6. The first layer of paint 52 extends between the innermost strips of masking tape 64a and 64g, i.e. the first suction-side strip 64a and the first pressure-side strip 64g. As such the first suction-side strip 64a defines a tapered suction-side edge 52a of the first paint layer 52, and the first pressure-side strip 64g defines a tapered pressure-side edge 52b of the first paint layer 52.

It should be appreciated that the Figures are schematic, and that the thickness of the paint layers is substantially less that than the diameter of the masking tape strips. The thickness of the paint layers and the tapered edges on the paint layers are thus exaggerated for clarity.

Referring now to FIG. 7, after spraying the first layer of paint 52, the first and second suction-side strips 64a, 64b (shown in FIG. 6) are removed from the outer surface 25 of the rotor blade 18 together with the first and second pressure-side strips 64g, 64h (also shown in FIG. 6). In other words, the two innermost strips of masking tape from each side of the leading edge 26 are removed after applying the first paint layer 52.

Removal of the first and second suction-side strips 64a, 64b exposes an uncoated area 74 between the tapered suction-side edge 52a of the first coating layer 52 and the third suction-side strip 64c of masking tape. Likewise, removal of the first and second pressure-side strips 64g, 64h, uncovers a further uncoated area 76 between the tapered pressure-side edge 52b of the first coating layer 52 and the third pressure-side strip 64i. The third strips 64c, 64i become the innermost remaining strips.

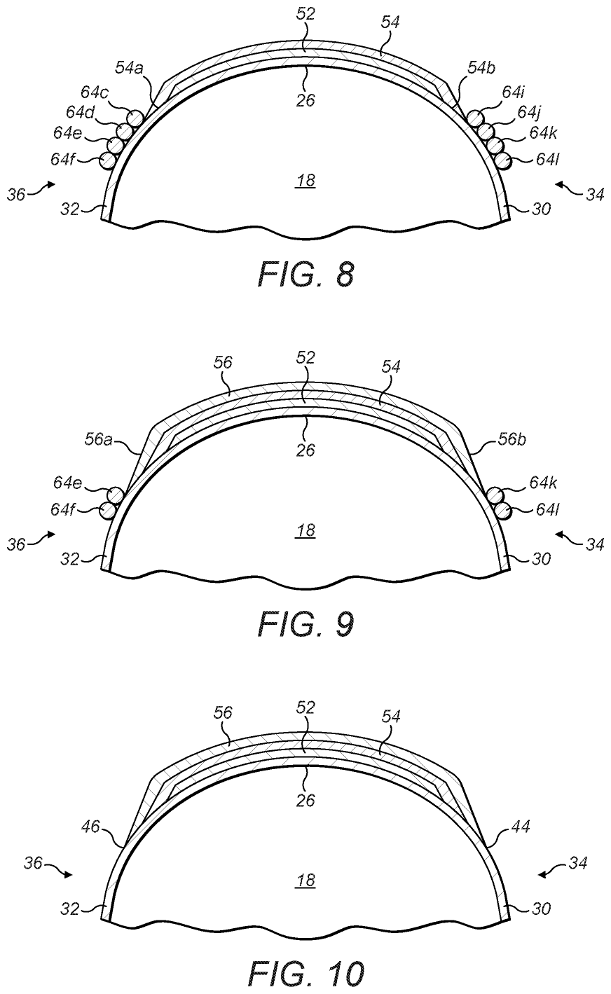

Referring now to FIG. 8, after removal of the two previously innermost strips of masking tape 64a, 64b, 64g, 64h from each side of the leading edge 26, a second layer 54 of paint is applied on top of the first layer 52 as well as on top of the newly exposed areas 74, 76, shown in FIG. 7. The second layer 54 extends between the third suction-side strip 64c and the third pressure-side strip 64i. As such, the third strips 64c, 64i of masking tape on each side of the blade 18 define tapered edges 54a, 54b of the second coating layer. The second layer 54 therefore extends over the tapered suction-side and pressure-side edges 52a, 52b of the first layer 52.

Referring now to FIG. 9, after spraying the second layer 54, the two innermost strips 64c, 64d, 64i, 64j (shown in FIG. 8) from each side are removed and a third layer of paint 56 is then applied on top of the second layer 54. The third layer 56 also covers the newly-exposed parts of the blade surface that were previously covered by strips 64c, 64d, 64i, 64j (shown in FIG. 8). The third layer 56 therefore extends between the fifth suction-side strip 64e of masking tape and the fifth pressure-side strip 64k of masking tape. As such, the fifth strip 64e, 64k on each side defines respective tapered edges 56a, 56b of the third coating layer 56.

After spraying the third layer 56, the remaining strips of masking tape 64e, 64f, 64k, 641 are removed and the coating 40 is now complete. The staggering of the outer edges of each layer of the paint 62 creates a smooth transition between the paint 62 and the uncoated surface of the rotor blade 18. As the edges of each paint layer are tapered, each subsequent paint layer is able to taper smoothly over the layer beneath it, so that there are substantially no steps or discontinuities within the paint layers. The building up of several layers each having a tapered edge allows thick coating to be applied whilst still providing a smooth transition between coated and adjacent uncoated parts of the blade.

Advantageously, the innermost strips of masking tape, as described in any of the embodiments above, are removed while the layer of paint defined by those strips is still wet. By removing the masking tape when the paint is still wet, the paint of that layer can flow over the surface of the blade, e.g. away from the leading edge, and thereby create a larger taper and a yet smoother transition.

The preferred time between spraying of the layer of paint and removal of the surrounding strips of masking tape will depend on the composition of the paint and the spraying environment i.e. the time it takes for the paint to dry to an extent where removal of the masking tape does not cause unwanted flow of the paint over the surface of the rotor blade. For example, in some embodiments, the innermost strip(s) of masking tape will be removed within 30 minutes of spraying the layer (preferably within 15 minutes, more preferably within 10 minutes and most preferably within 5 minutes), depending for example on factors such as the layer thickness and cure time of the paint. Preferably the tape is removed as fast as possible after applying a coating layer so that the paint has the ability to flow sufficiently and form a smooth edge.

As such, the strips of masking tape are advantageously applied to the outer surface of the rotor blade such that they may be quickly and easily removed from the rotor blade surface after spraying of a layer of paint. For example the strips of masking tape may be removably attached by an adhesive strip formed on the strips of masking tape, as described above. The strips of masking tape with their respective adhesive strips are each applied directly to the outer surface of the rotor blade. However other means of applying the masking tape are envisaged, for example, the masking tape may be glued to the outer surface of the rotor blade using glue applied to the masking tape and/or the outer surface of the rotor blade or by any other attachment means that facilitates quick removal therefrom.

In the described embodiment three layers of paint are applied. However, it will be appreciated that the benefits of the invention could apply to coatings having only two layers of paint and/or having more than three layers, for example four, five, six or more layers. The number of layers present in the coating is dependent on the desired final coating thickness and the fluid properties of the layers. In preferred embodiments, the thickness of each coating layer is preferably approximately 250+/−50 microns, but the thickness may vary depending upon the sag resistance of the paint, and the required overall thickness required.

The composition of the coating in each layer may be substantially the same. Preferably the coating is a polyurethane-based coating. In some embodiments the layers may comprise different additive such as different colourants to distinguish the layers. The coating of the illustrated embodiment is a leading edge protection (LEP) coating to increase the rotor blade's ability to resist erosion at the most exposed area of the rotor blade, for example a polyurethane-based paint. However, it will be appreciated that the method disclosed herein could be used to apply other types of coating, and/or may be applied to areas of a rotor blade other than the leading edge.

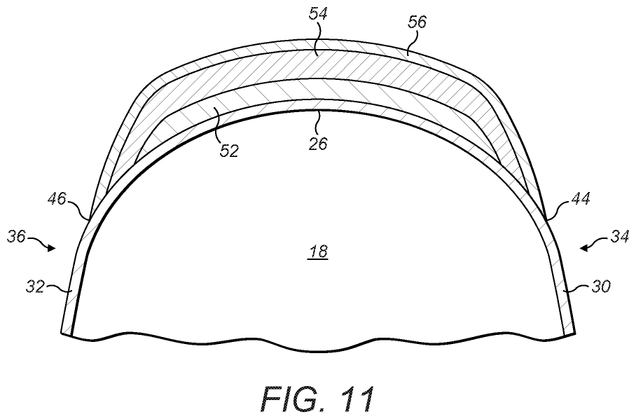

In a further embodiment shown in FIG. 11, the outermost layer 56 of the coating 40 may be thinner than the inner coating layers 52, 54. A thinner outer layer 56 may create a closed film so that the transition at each edge of the final coating 40 will be as smooth as possible. A further top coat may also be provided over the entire rotor blade 18 including over areas coated and uncoated by the LEP coating 40.

In the embodiment of FIGS. 5 to 10, six strips of masking tape are positioned on either side of the rotor blade 18 in order to define the coating area 38. However, it will be appreciated that any number of strips of masking tape may be used e.g. depending on the number of layers of the coating 40, the size of the strips of masking tape and/or the desired taper. In the described embodiment, the two innermost strips are removed from each side after each coating layer is sprayed. However, in variants of this embodiment, one strip, or more than two strips could be removed from each side prior to applying the next coat, depending upon the desired offset size between the tapered edges of successive coating layers. In general, one or more strips of masking tape may be removed after each layer is applied.

In general, at least two strips of masking tape are required at each edge region of the coating area such that an outermost strip of the at least two strips defines the final outer edge of the coating 40 and the innermost strip of the at least two strips defines the outer edge of a first layer 52 of the coating 40. Any number of strips of masking tape may be positioned between the innermost and outermost strips to create further layers as desired. Further strips of masking tape or other masking materials may be provided outside of the outermost strip to further protect the rotor blade 18 during spraying. More generally, an area of the final coating is identified and a plurality of strips is applied proximate an edge of that area i.e. an edge region of the final coating. It will be appreciated that the strips forming intermediate layers of the coating will be positioned within the area with the innermost strips defining the first coating layer and the outermost strip(s) being positioned at the edge of the area such that any overhang created by the outermost strips(s) projects over the edge into the area. It will be appreciated that the ‘innermost’ strip is the strip that is positioned furthest from the edge, within the area to be coated. It will also be appreciated that after the innermost strip is removed, the strip that was immediately adjacent the removed strip will latterly become the innermost remaining strip or innermost strip with respect to the next layer to be sprayed.

Furthermore a larger strip of masking tape may provide a larger taper of a respective coating layer and can provide larger spacing between the edges of the coating layers. It will also be appreciated that the strips of masking tape may be spaced from one another in order to create the desired spacing between the edges of the layers. In embodiments where the strips of masking tape are spaced from one another a further masking material may be positioned between the strips of masking tape, if desired, in order to prevent paint 62 from contacting the rotor blade 18 outside the required area.

In the illustrated embodiments, the strips of masking tape all have substantially the same cross-sectional shape and size, however it will be appreciated that a variety of shapes and sizes may be used e.g. depending on the desired taper of the paint 62 at the various edges thereof or the nature of the spray etc.

In some embodiments, the strips of masking tape do not necessarily extend in a straight line along the span S of the rotor blade 18. For example a curved or irregular coating shape may be desired, in which case the strips of masking tape may be arranged such that they extend in a curved or irregular line to form the desired coating shape.

Furthermore the strips of masking tape need not necessarily extend parallel to one another. For example, the spacing between the strips may be varied in order to provide a varying taper along the span of the blade.

In the described embodiments, the strips of masking tape are arranged substantially symmetrically about the leading edge 26 of the rotor blade 18. However, other arrangements of the tapes are envisaged, e.g. depending on the shape of rotor blade 18 and/or desired geometry of the area to be painted. For example the coated area may extend further over the pressure surface 30 than the suction surface 34 or vice versa. Also, the coated area may extend over only a portion of the span S of the rotor blade 18, for example in a region adjacent the tip 24 of the rotor blade 18.

The strips of masking tape may comprise separate strips of masking tape but, in other embodiments, a continuous length of tape could be used to form the various strips of masking tape for example by arranging the tape in a serpentine manner. Alternatively, one or more strips of masking tape could be formed together or attached to each other along their lengths. In such embodiments, the strips of masking tape may include perforations or lines of weakness therebetween such that the different strips may be separately removable in accordance with the above disclosed method.

The use of more than one strip of masking tape 64 on either side of the leading edge 26 may perform a number of functions to improve the final coating 40. For example, additional strips of tape 64 may further protect the uncoated areas from paint spray 62 particularly when the innermost strips of masking tape 64 do not sufficiently cover the surrounding surface. This may allow a greater range of shapes and sizes to be used for the innermost strips of masking tape 64 which may therefore be carefully selected, i.e. in terms of their shape and size, to provide the optimum taper at the edge of the coating 40.

Generally, the disclosure relates to a method of and apparatus for coating an outer surface 25 of a wind turbine rotor blade 18, in which a smoother transition is achieved between the coated and uncoated areas thereof. In particular, a smooth transition is achieved by having a coating that tapers towards its edge; that is the thickness of the coating reduces towards an outer edge of the coating.

By having a coating including at least two layers and staggering the edges of these layers such the edge of each subsequently applied layer extends beyond an outer edge of the preceding layer, the thickness of the coating 40 gradually decreases or tapers towards the edge of the coating such that the final coating has a thickness at its outer edge that is, at most, the thickness of the outermost coating layer. The applicant has found that this tapering may create a smoother transition which minimises unwanted flow effects on and adjacent the coating 40. In particular, the applicant has found that arranging a plurality of strips of masking tape and spraying individual coating layers such that subsequent layers extend over an edge of preceding layers and onto an uncoated area provides this effect. A yet smoother transition may be achieved by tapering each of the individual coating layers through the use of rounded masking tape and/or removing the tapes while the paint is still wet. Further features of this method and apparatus have been found to further improve this effect as described in relation to the various embodiments above.

1. A method of coating an area of a wind turbine rotor blade, the method comprising:
(i) defining an area to be coated on a surface of the blade;
(ii) applying a first plurality of strips of masking tape to the surface of the blade proximate a first edge of the defined area such that each strip is arranged adjacent to at least one other strip of said first plurality of strips;
(iii) spraying a coating layer onto the defined area up to an innermost strip such that the innermost strip defines an edge of the coating layer;
(iv) removing the innermost strip(s) to expose an uncoated region of the defined area between the edge of the coating layer and an innermost remaining strip;
(v) spraying a further coating layer over the previous coating layer and over the uncoated region up to said innermost remaining strip; and
optionally repeating steps (iv) and (v) until a coating having a desired thickness is achieved.

2. The method of claim 1, wherein step (ii) further comprises:
applying a second plurality of strips of masking tape to the surface of the blade proximate a second edge of the defined area such that each strip of the second plurality of strips is arranged adjacent to at least one other strip of the second plurality of strips, wherein step (iii) comprises spraying the coating layer onto the defined area between the innermost strips of the first and second plurality of strips and step (iv) comprises removing the innermost strip(s) of the first and second plurality of strips prior to spraying a further coating layer.

3. The method of claim 2, wherein step (ii) comprises applying the first plurality of strips to one of a pressure surface or a suction surface of the blade, and applying the second plurality of strips to the other of the pressure surface or the suction surface.

4. The method of claim 1, wherein the defined area is a leading edge region of the blade comprising a leading edge of the blade.

5. The method of claim 1, further comprising allowing the coating layer to dry prior to spraying the further coating layer in step (v).

6. The method of claim 1, wherein step (iv) comprises removing the innermost strip(s) while the coating layer is still wet so that the coating flows towards the innermost remaining strip.

7. The method of claim 1, wherein step (ii) comprises temporarily adhering the strips to the surface of the rotor blade.

8. The method of claim 1, comprising spraying an outermost coating layer, such that the outermost coating layer is thinner than at least one inner coating layer beneath the outermost coating layer.

9. An assembly comprising a wind turbine rotor blade and an apparatus for applying a coating on a defined area of a surface of said wind turbine rotor blade according to the method of claim 1, the apparatus comprising:
a plurality of strips of masking tape arranged on the surface of the rotor blade and aligned with each other proximate a leading edge of the rotor blade; and
means for spraying a coating composition onto the leading edge of the rotor blade up to an innermost strip of the plurality of strips.

10. The method or assembly of claim 1, wherein the plurality of strips of masking tape includes at least four strips, two of the strips being arranged on a pressure side of the leading edge and two of the strips being arranged on a suction side of the leading edge.

11. The method or assembly of claim 1, wherein each strip of the plurality of strips of masking tape is shaped such that, when the strips are attached to the surface of the blade, a portion of each strip overhangs the defined area to be coated, wherein an overhanging portion of a strip serves to create a tapered edge in a coating layer sprayed up to said strip.

12. The method or assembly of claim 1, wherein the plurality of strips of masking tape are made from a foam or rubber material.

13. A wind turbine blade comprising a leading edge protection coating covering a leading edge region of a surface of the blade, wherein the leading edge protection coating comprises:
an outer coating layer; and
at least one inner coating layer between the outer coating layer and the surface of the blade, wherein the outer coating layer extends beyond at least one edge of the at least one inner coating layer in a direction towards a trailing edge of the blade such that the leading edge protection coating tapers in thickness in a direction towards the trailing edge.

14. The wind turbine blade of claim 13, wherein the at least one inner coating layer includes an innermost coating layer and at least one intermediate coating layer between the innermost coating layer and the outer coating layer, the at least one intermediate coating layer extending beyond at least one edge of the innermost coating layer in a direction towards the trailing edge of the blade.

15. The wind turbine blade of claim 13, wherein each of the coating layers tapers in thickness in a direction towards the trailing edge of the blade.
